(19) United States
(12) Patent Application Publication
(10) Pub. No.: US 2002/0072355 A1
(43) Pub. Date: Jun. 13, 2002

(54) Method for distributing application software in mobile communication system

(76) Inventors: Gi-O Jeong, Seoul (KR); Un-Rak Lee, Kyoungki-do (KR)

Correspondence Address: STAAS & HALSEY LLP, 700 11TH STREET, NW, SUITE 500, WASHINGTON, DC, 20001, US

(21) Appl. No.: 09/848,347

(22) Filed: May 4, 2001

(30) Foreign Application Priority Data
Dec. 11, 2000 (KR) 2000-75282

(51) Int. Cl. H04M 3/00

(52) U.S. Cl. 455/419; 455/418; 455/556

(57) ABSTRACT

In the method for distributing application software, a mobile station receives the application software from an application software distribution system to upgrade or install the application software, and an application program less used in the mobile station is stored at the application software distribution system, and whenever necessary, the program is again installed and used. The inventive method includes the steps of: a) initializing to distribute application software files to a mobile station; b) receiving an application software transmission/reception requiring message from the mobile station; c) if the application software transmission requiring message is received, transmitting the application software file to the mobile station; and d) if the application software reception requiring message is received, receiving the application software file from the mobile station.

### FIELD OF THE INVENTION

The present invention relates to a method for distributing application software used in a radio communication system and a record medium capable of being read through a computer having a writing of a program to realize the inventive method; and, more particularly, to a method for distributing application software and a record medium capable of being read through a computer having a writing of a program to realize the inventive method, in which application software used in a mobile station is upgraded or new application software is installed or application software used less is stored at other storage.

### DESCRIPTION OF THE PRIOR ART

A mobile station is being used for radio communication subscribers who need to receive various kinds of application services such as positional information and geographical information etc. as various radio portal services.

However, in order to provide the application service based on such various types of characteristics, plenty of application software must be installed.

Therefore, though a service providing technique such as a distribution of application software through a radio communication network was not developed, the software can be distributed by using an electronic mail etc.

However, there are many problems in applying the application software distributing method using such electronic mail etc. to the communication network.

Further, when a user of the mobile station desires to receive an application service embodied by a specific application program without a use of browser basically provided in a mobile station, a concerning application software should be installed in the mobile station but there is a problem of a shortage for a storing space of the mobile station in which such application software can be installed.

### SUMMARY OF THE INVENTION

Therefore, it is an object of the present invention to provide a method for distributing application software and a record medium capable of being read through a computer having a recording of a program to realize the inventive method, in which a mobile station receives application software from an application software distribution system, and upgrades or installs the application software, and an application program less used in the mobile station is stored at the application software distribution system and is again installed in the mobile station if necessary.

In accordance with an aspect of the present invention, there is provided a method for distributing application software applied to an application software distribution system, comprising the steps of: a) initializing to distribute application software files to a mobile station; b) receiving an application software transmission/reception requiring message from the mobile station; c) if the application software transmission requiring message is received, transmitting the application software file to the mobile station; and d) if the application software reception requiring message is received, receiving the application software file from the mobile station.

In accordance with another aspect of the present invention, there is provided a method for distributing application software file applied to a mobile station, comprising the steps of: a) performing an initialization in the mobile station; b) transmitting an application software transmission/reception requiring message to an application software distribution system; c) if the application software transmission requiring message is transmitted, receiving an application software file from the application software distribution system; and d) if the application software reception requiring message is transmitted, transmitting the application software file.

In accordance with further another aspect of the present invention, there is provided a computer readable record medium storing instructions for executing a method for distributing application software applied to an application software distribution system, the method comprising the steps of: a) initializing to distribute application software files to a mobile station; b) receiving an application software transmission/reception requiring message from the mobile station; c) if the application software transmission requiring message is received, transmitting the application software file to the mobile station; and d) if the application software reception requiring message is received, receiving the application software file from the mobile station.

In accordance with still further another aspect of the present invention, there is provided a computer readable record medium storing instructions for executing a method for distributing application software applied to an mobile station, the method comprising the steps of: a) performing an initialization in the mobile station; b) transmitting an application software transmission/reception requiring message to an application software distribution system; c) if the application software transmission requiring message is transmitted, receiving an application software file from the application software distribution system; and d) if the application software reception requiring message is transmitted, transmitting the application software file.

### BRIEF DESCRIPTION OF THE DRAWINGS

The above and other objects and features of the instant invention will become apparent from the following description of preferred embodiments taken in conjunction with the accompanying drawings, in which:

FIG. 1 represents a constructive exemplary diagram of an application software distribution system in accordance with the present invention;

FIG. 2 presents a block diagram for one embodiment of an application software distribution system in the present invention;

FIG. 3 is an exemplary explanatory diagram showing a service method in an inventive application software distribution system;

FIG. 4 is an explanatory diagram of an application software distributing method using a radio communication network in one embodiment of the present invention;

FIG. 5 provides a flow chart for an application software distributing method using a radio communication network in one embodiment of the present invention;

FIGS. 6A and 6B show flow charts for another embodiment of an application software distributing method using an inventive radio communication network; and

FIGS. 7A and 7B illustrate flow charts for a still another embodiment of an application software distributing method using an inventive radio communication network.

### PREFERRED EMBODIMENT OF THE INVENTION

Hereinafter, preferred embodiments of the present invention will be described in detail with reference to the accompanying drawings.

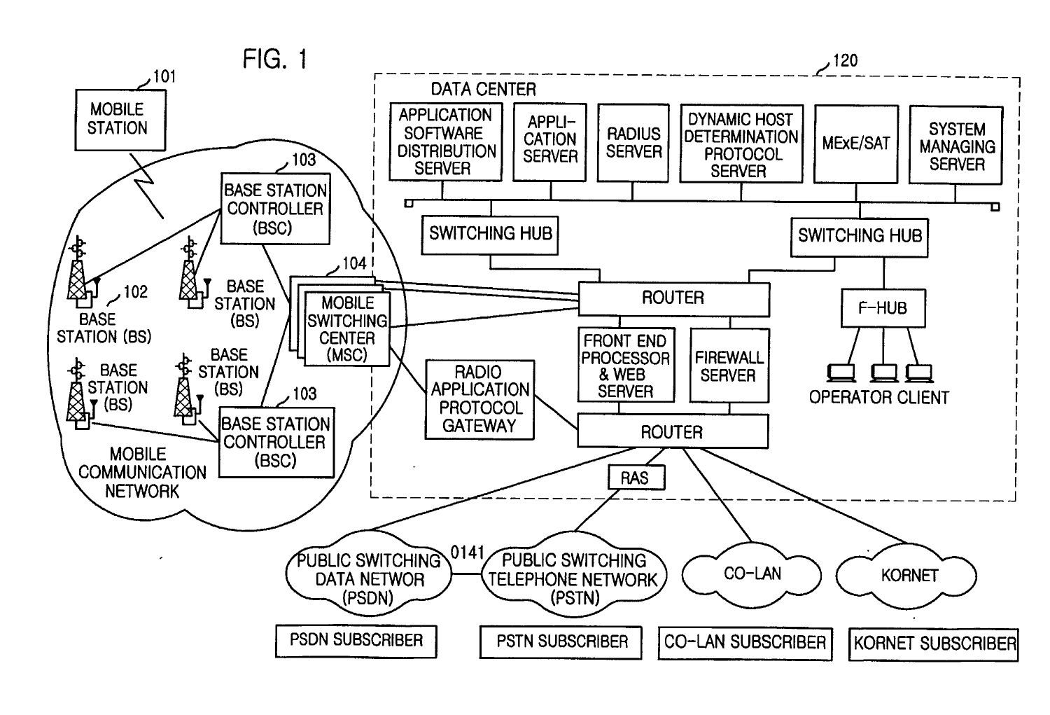

FIG. 1 is a constructive exemplary diagram of an application software distribution system in accordance with the present invention. In FIG. 1, a reference number 101 represents a mobile station, 102 as a base station (BS), 103 as a base station controller (BSC), 104 as a mobile switching center (MSC), and 105 indicates a data center.

The mobile station 101 exists within a range of an optional base station 102, and information of the mobile station 101 is transmitted to the mobile switching center 104 through the base station 102 and the base station controller 103 for controlling the base station. The information transmitted from the mobile switching center 104 is transmitted to the mobile station 101 through the base station 102 and the base station controller 103.

Data transmitted and received from the mobile station 101 is coupled with the mobile switching center 104 through the base station 102 provided for a high frequency (HF) signal process and a call process and through the base station controller 103.

The base station (BS) 102 performs a wire/radio converting function of communicating with the mobile station 101 in the radio and communicating with the base station controller (BSC) 103 via wire.

The base station controller (BSC) 103 adjusts a connection between the base stations 102 by coupling the base station 102 with the mobile switching center 104, and performs a signal process function for a communication between the base station 102 and the mobile switching center 104.

The MSC 104 is coupled with the base station controller 103 to perform a conversation determination and release function of the mobile station 101 etc. and also performs a call process and several kinds of functions relating to an additional service.

The data center 105 is interlocked with an application software distribution system as a server, a system management server within the data center, an MExE/SAT server, a DHCP server and an RADIUS etc. and is also coupled with an internet and a radio communication network, to provide a service to a user.

Particularly, the application software distributing server provides a personal mobile station 101 as a client with various application software distribution services through the radio communication network.

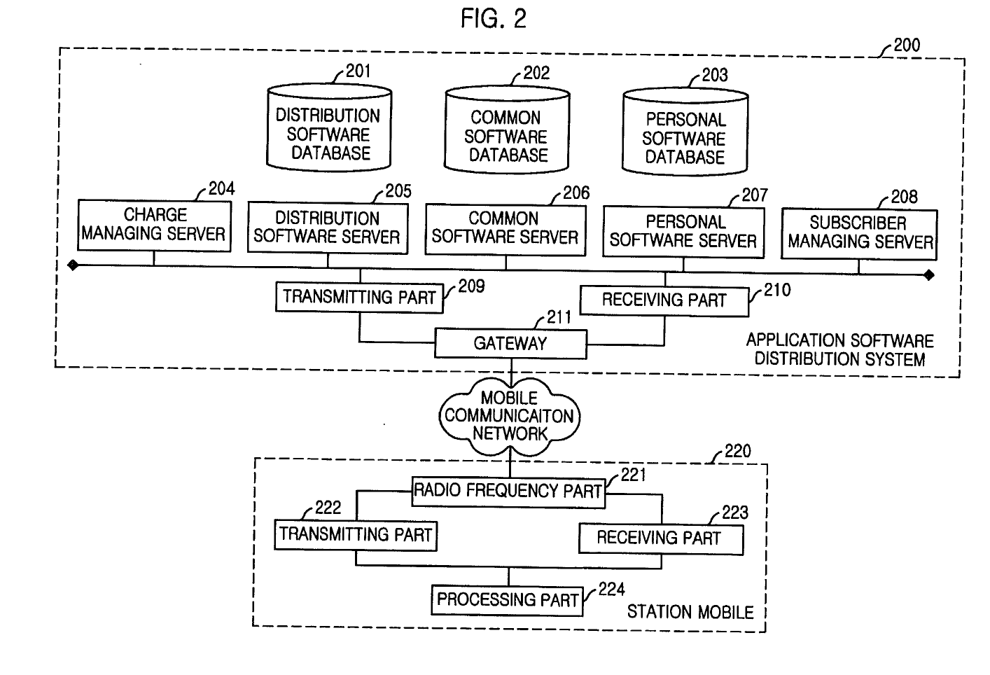

An operation between the mobile station 101 and the application software server of the data center 120 will be described in detail as follows, with reference to FIG. 2 to be later explained.

FIG. 2 is a block diagram for one embodiment of an inventive application software distribution system, and shows the construction for principal constructive elements of the application software distribution system as a server and the personal mobile station as a client.

At present, it is being required to provide a central server capable of permitting a constant storing space to each personal of a radio communication subscriber, and is being also needed an application software distribution system capable of distributing the application software by using the radio communication network having a characteristic of push and pull services.

As shown in FIG. 2, the application software distribution system 200 includes a distribution software database 201 as a storage for storing distribution software, a common software database 202 for storing common software, and a personal software database 203 for storing personal software. As the server, it includes a charging server 204 for managing a charge, a distribution software server 205 for managing the distribution software, a common software server 206 for managing the common software, and a personal software server 207 for managing the personal software, and a subscriber managing server 208 for managing a user. Here, included are a transmitting part 209 for transmitting signals outputted from the servers, a gateway 211 for sending signals outputted from the transmitting part 209, to a mobile station 220, and a receiving part 210 for sending the signals received from the mobile station 220, to the servers.

The mobile station 220 is composed of a radio frequency part 22 for receiving a signal transmitted from the application software distribution system 200 and outputting a signal outputted from the mobile station 220, to the application software distribution system, a transmitting part 222 for transmitting the signal processed in a processing part 224 of the mobile station 220, a receiving part 223 for processing the signal received from the application software distribution system, and the processing part 224 for processing the reception signal or the transmission signal.

The application software distribution system 200 has a distribution software managing function of managing a new and version-up relating application software of the mobile station 220, a common software managing function of managing the application software commonly used in all the mobile stations, and a personal software managing function of managing the individual application software in all the mobile stations, etc.

Further, the application software distribution system 200 provides a storing space to store and manage radio personal application software, and has a function of managing, supervising and monitoring the storing space to provide the application software desired by a user of the mobile station. In the application software distribution system 200, a using period of the mobile station user is automatically checked, and in a case of being not used for a constant period in the checking result, a data backup for data and information stored by the mobile station user is automatically performed by using a data backup equipment etc. In addition, such storing space is differentially provided according to age and occupation of the mobile station user, etc. Herewith, the age can be checked through a resident registration number of the mobile station user.

As a communication protocol between the application software distribution system 200 and the mobile station 220, it is used a transmission control protocol/internet protocol (hereinafter, referred to as “TCP/IP”).

In the mobile station 220, a Point-to-Point protocol (hereinafter, referred to as “PPP”) is initialized, and the TCP/IP is driven after a completion of the PPP initialization, and an application program of a data terminal transmits a MODEM initialization command at a time point when the initialization of the TCP/IP is completed. In such construction, a reliable data transmission can be obtained with an Internet connection environment and a computer environment in the radio communication network.

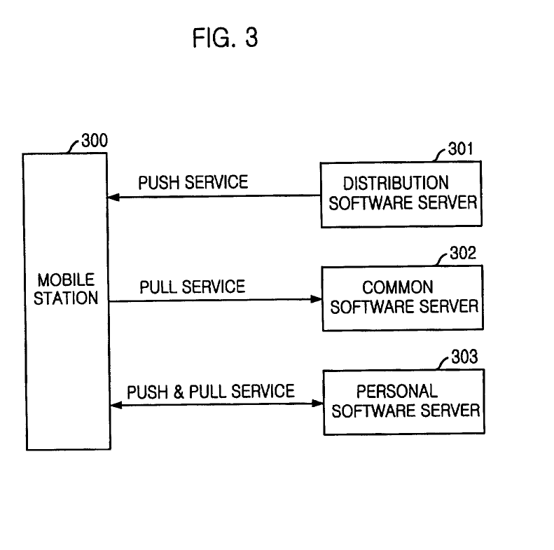

FIG. 3 is an exemplary explanatory diagram showing a service method of the inventive application software distribution system. In the system of FIG. 3, an agent for a client is set in the mobile station to transmit and receive a program with the application software distribution system for use of a server by push/pull, and the application software based on a latest version is used in the mobile station side so as to receive a radio multimedia service. This system also provides a service relating to a distribution software server, a common software server and a personal software server.

As shown in FIG. 3, the push service is provided to be automatically installed by distributing application software to a mobile station 300 of the radio communication subscriber when the application software concerning of the radio communication is developed, and the mobile station 300 transmits it to a distribution software server 301.

In the pull service, it represents that the mobile station 300 retains only several number of application software used in a basic space of the mobile station 300 and unnecessary application software is automatically deleted, since a space as a storage medium is shortage in the mobile station 300, and that the deleted application software is sent to a common software server 302 having a database for storing the application software used in common, and the deleted application software is used through an automatic download whenever necessary.

The push/pull services represent that only the application software used in the mobile station 300 is stored at a mobile station of the radio communication subscriber oneself, that is, that only several number of application software usable in the basic space of the mobile station is possessed into the mobile station, and the rest is stored at a personal space of the radio communication subscriber of a personal software server 303 and is used through an automatic download installment whenever necessary.

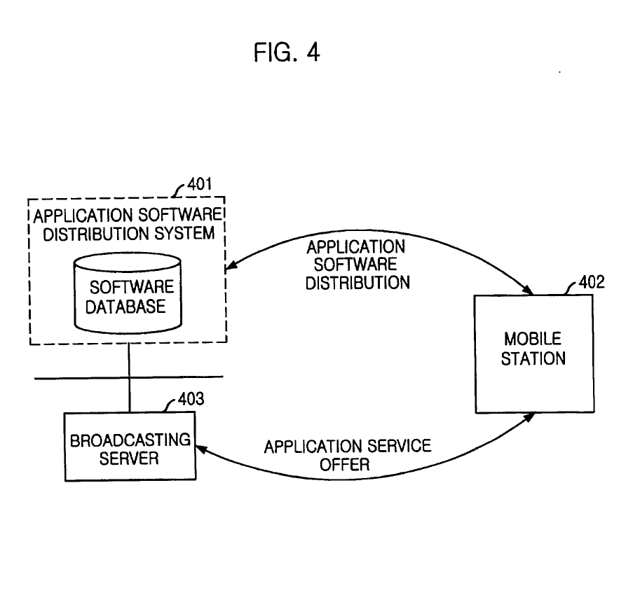

FIG. 4 is an explanatory diagram for a concentrated application service providing method using an inventive radio communication network. In FIG. 4, it is shown a flow diagram for a method that a cookie automatically coupled with the URL of the application service site attached to the application program is executed to be connected to a specific server when the application software provided from the application software distribution system 401 is executed, namely, is shown the concentrated application service providing method.

In this system, the client agent is installed in the mobile station 402, and the program is transmitted to the server application software distribution system 401 and the push/pull, and the application software of the latest version is used in the mobile station 402 side to have the radio multimedia service. Since every the installed application software has the URL of the specific site server relating to the service, the client agent is automatically linked with an application software relating server so as to receive a service in an opened radio network, instead of a closed radio network, when a user of any mobile station requests a service relating to the installed application software.

In one example, when broadcasting media player application software from the application software distribution system 401 is down-loaded and installed in the mobile station 402, the URL relating cookie as the application service site is automatically installed in the application program. At this time, when the media player is executed according that the radio communication user requires to watch an entertainment broadcast program, the URL relating cookie is coupled with a broadcasting server 403 set in the radio data center to provide the entertainment broadcast service to the radio communication user.

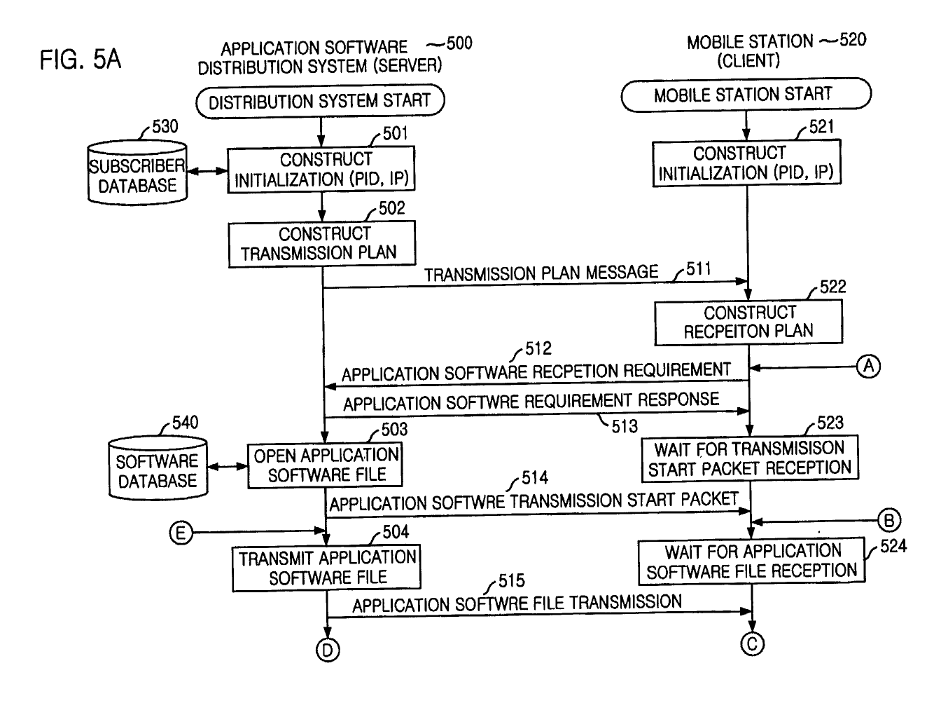

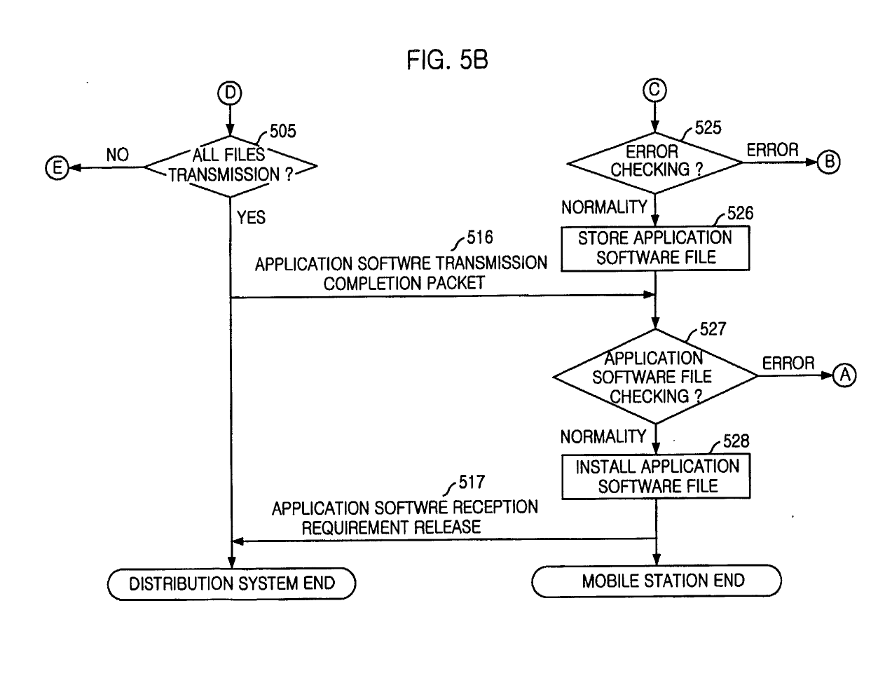

FIG. 5 is a flow chart for the application software distributing method using the inventive radio communication network in one embodiment of the present invention. In FIG. 5, it is represented a distribution software distributing service, in which functions required in respective systems in performing the distribution software distributing service and the radio communication relating application software are developed to enable to distribute the application software to the mobile station of the radio communication subscriber and to automatically install it therein and use it in the mobile station.

As shown in FIG. 5, an application software distribution system 500 as the server and a mobile station 520 as the client are initialized in steps 501 and 521. At this time, the application software distribution system 500 as the server is interlocked with a subscriber database 530 in the initialization, to generate a PID value for transmitting a transmission plan message, and stores the PID value allocated for the distribution of the application software and a multicast IP address value used for the distribution of the application software.

The mobile station 520 as the client determines the PID value for receiving a transmission plan message in the initialization, as a variable, and stands by to receive and process a packet transmitted from the application software distribution system 500 as the server.

Next, when the initialization is determined between the application software distribution system 500 as the server and the mobile station 520 as the client, the application software distribution system 500 as the server performs a transmission program of the application software distribution system 500 to distribute the software, and the transmission program constructs the transmission plan in a step 502, to send a transmission plan message 511 to the mobile station as the client.

Then, when the mobile station 520 receives the transmission plan message 511 from the application software distribution system 500 as the software transmission server, an application software reception program is executed according to the transmission plan and a reception plan is constructed in a step 522, and after that, the mobile station 520 transmits an application software reception requiring message 512 to the application software distribution system 500 as the server.

The application software distribution system 500 having the reception of the application software reception requiring message 512 sends an application software requirement response message 513 to the mobile station 520, and opens and reconstructs an application software file in a software database 540 in a step 503, with the PID value of the application software to be distributed.

At this time, when the mobile station 520 receives the application software requirement response message 513 from the application software distribution system 500, it becomes a standing-by state to receive an application software transmission start packet in a step 523.

Subsequently, the application software distribution system 500 transmits an application software transmission start packet 514 to the mobile station 520 and also sends the application software file in a step 504. Then it is clarified whether or not all the files are transmitted, in a step 505.

In case that there yet is the application software remained to be transmitted in the clarification result, it is progressed an application software file transmitting procedure 504.

The mobile station 520 receives the application software file in a step 515 under the application software file reception stand-by state 524. The mobile station performs an error checking for the received application software file, to clarify whether there is an error in a step 525. Herewith, if there is the error in the clarification result, the received application software file is abandoned and it goes to a step 524 of standing by an application software file reception.

In case that there is no the error in the result of clarifying whether or not the mobile station 520 has the error, the received application software file is stored at the mobile station 520.

Next, when the application software distribution system 500 transmits all the transmission application software files, an application software transmission completion packet 516 is sent to the mobile station 520.

Then, the mobile station 520 checks in a step 527 whether or not all reception packets were normally received, after the reception of the application software transmission completion packet 516, and in a case of the normal reception, the received file is automatically installed in the mobile station 520 in a step 528. Also an application software reception requirement releasing message 517 is sent to the application software distribution system 500 as the server. Then the reception program of the mobile station is finished.

If there is the error in the application software in an application software file checking result of a step 527, it goes to a step 512 of sending an application software reception requirement to the application software distribution system 500.

Then, the application software distribution system 500 receives the application software reception requirement releasing message 517 and the transmission program is completed.

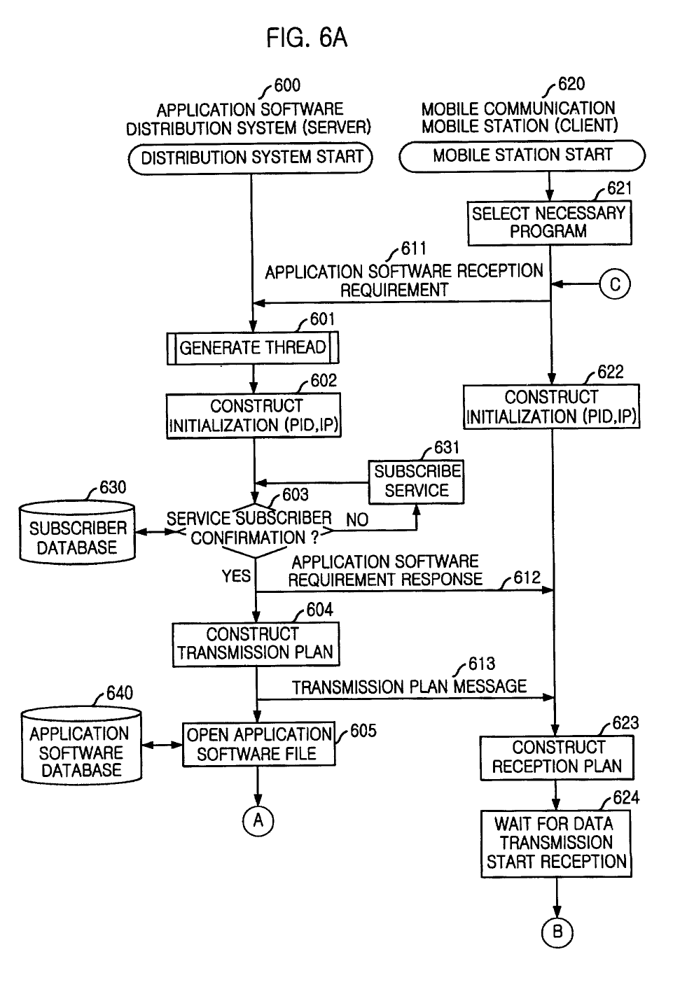

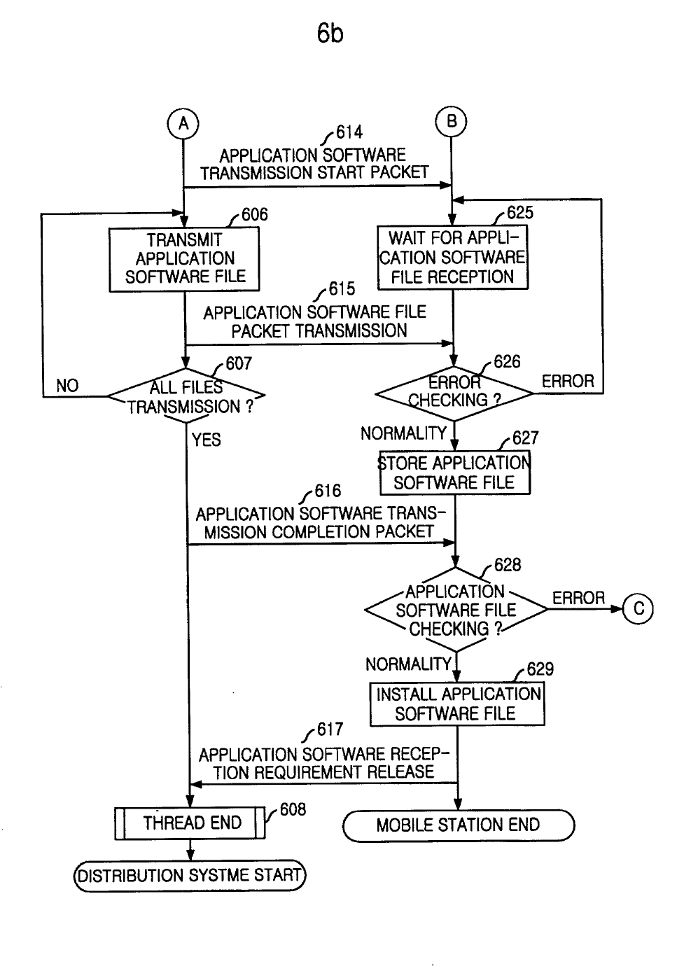

FIGS. 6a and 6b are flow charts for another embodiment of the application software distributing method using the inventive radio communication network, and represent functions to be performed in individual systems in executing a common software distribution service.

In FIGS. 6a and 6b, it is represented a common software distribution service that the mobile station retains only several number of application software usable in a basic space of the mobile station and unnecessary application software is automatically removed, since a space as a storage medium is shortage in the mobile station, and that the removed application software is installed and used through an automatic download from an application software database commonly using the removed application software whenever necessary.

As shown in FIGS. 6a and 6b, when a mobile station 620 as the client desires to receive any service but there is no concerned application software, the cookie of the mobile station selects a desired program in a step 621 and sends a reception requirement for the application software to the application software distribution system in a step 611.

The application software distribution system 600 as the server having the reception of an application software reception requiring message 611 provided from the mobile station 620 generates a thread in a step 601, and it becomes initialized in a step 602. Herewith, in the initialization, a PID value for transmitting a transmission plan message is generated, and the PID value allocated for the distribution of the application software and a multicast IP address value used for the distribution of the application software are stored.

The mobile station 620 also determines the PID value for receiving the transmission plan message in the initialization, as a variable, and stands by to receive and process a packet transmitted from the application software distribution system 600, in a step 622.

When the initialization was determined between the application software distribution system 600 and the mobile station 620, a next working starts to distribute the application software.

The application software distribution system 600 first searches for a subscriber database 630 to clarify in a step 603 whether it is a service subscriber. If it is the service subscriber in the clarification result, an application software requirement response message 612 is transmitted to the mobile station 620, and a transmission program of the application software distribution system is performed in order for a distribution of the software. The transmission program constructs a transmission plan in a step 604 and transmits a transmission plan message to the mobile station 620.

If not the service subscriber in the result of clarifying whether or not it is the service subscriber, a service subscription requiring step 631 is performed and the clarification step 603 is then progressed.

Meantime, when the mobile station 620 receives the application software requirement response message 612 and the transmission plan message 613 from the application software distribution system 600, an application software reception program is executed according to the transmission plan and a reception plan is constructed in a step 623, to then wait for an application software transmission start packet in a step 624.

In the second place, the application software distribution system 600 opens an application software file in an application software database 640 in a step 605, with a PID value of the application software to be distributed, and reconstructs it. Then it is clarified whether or not all the files are transmitted, in a step 607. In case that there yet is the application software remained to be transmitted, it is progressed an application software file transmitting step 606, and if all the files were transmitted, an application software transmission completion packet 616 is sent to the mobile station 620.

Meanwhile, the mobile station 620 receives an application software transmission start packet 614 from the application software distribution system 600, and after that, receives an application software file 615 under an application software file reception stand-by state 624. The mobile station 620 performs an error checking for the received application software file 615, in a step 626. Herewith, if there is an error, it goes to a step 625 of standing by an application software file reception, and if there is no the error, the mobile station 620 stores the received application software file in a step 627.

Also, when the application software transmission completion packet 616 is received from the application software distribution system 600, the mobile station 620 as the client checks the application software file in a step 628 whether all the received packets are normally performed. In a case of all the normal reception in the checking result, the received file is automatically installed in the mobile station 620 in a step 629. Then, an application software reception requirement releasing message 617 is transmitted to the application software distribution system 600 and it becomes completed.

However, in case that there is the error in the application software file, it goes to a step 611 of presenting the application software reception requirement to the application software distribution system 600.

While, when the application software distribution system 600 receives the application software reception requirement releasing message 617, the transmission completion program is finished.

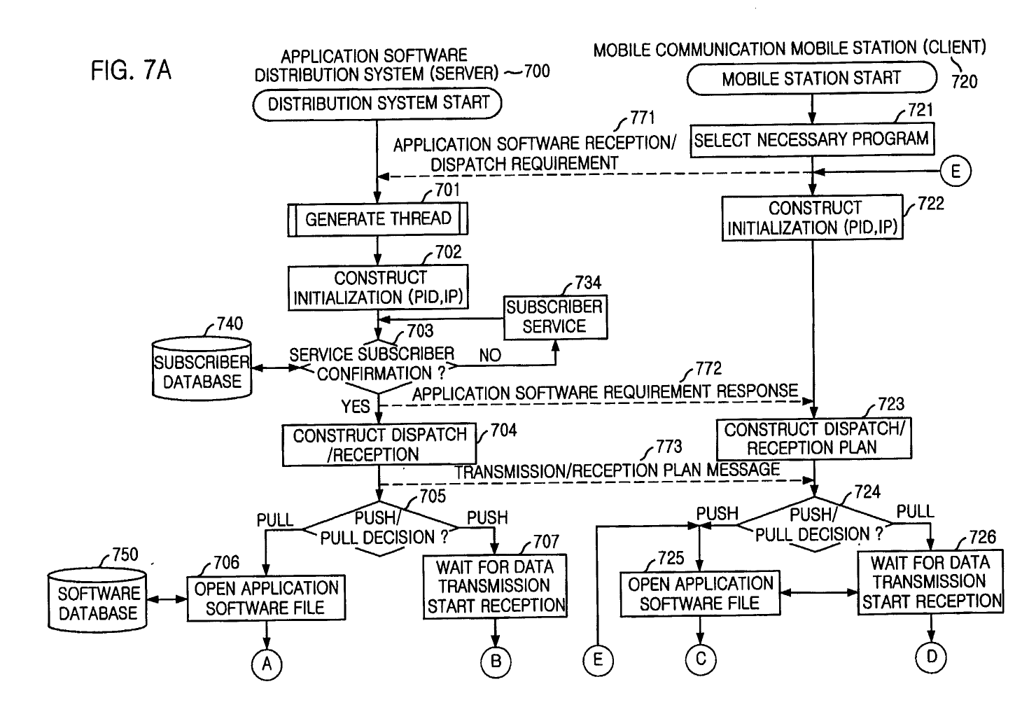

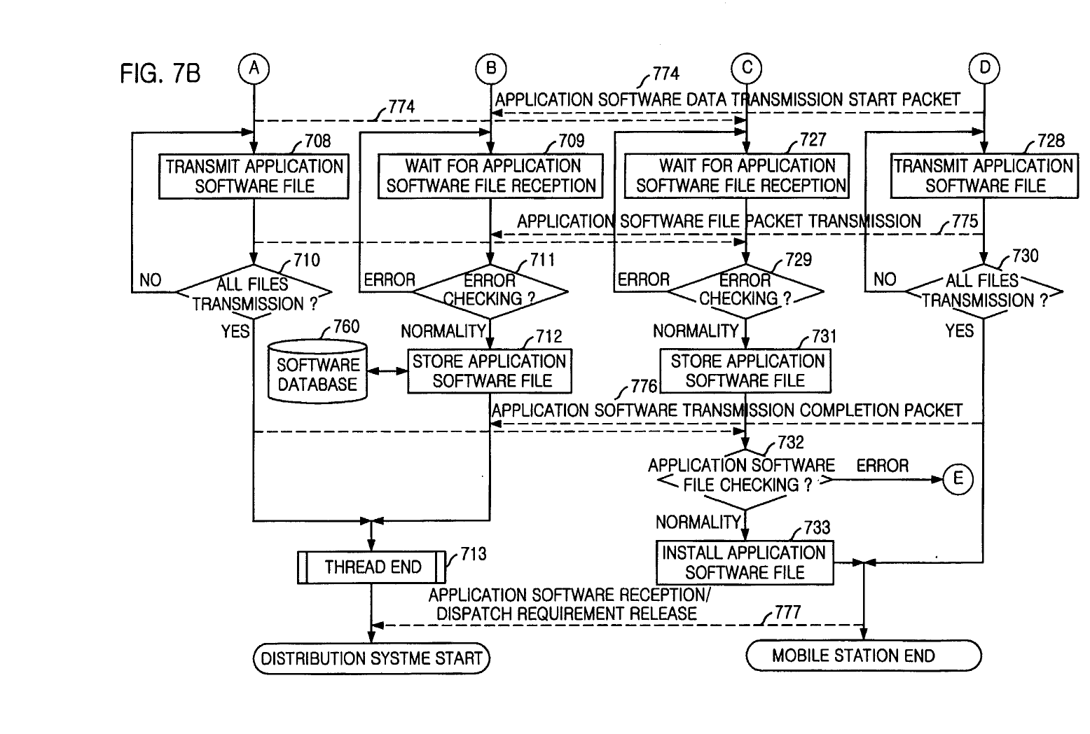

FIGS. 7A and 7B are flow charts for a still another embodiment of the application software distributing method using the inventive radio communication network, and represent functions to be performed in respective systems in executing a personal software distribution service.

In FIGS. 7A and 7B, it is represented a personal software distribution service that only the application software used in the mobile station is stored at a mobile station of the radio communication subscriber oneself, that is, the mobile station retains only several number of application software usable in the basic space of the mobile station and the rest is stored at a personal space of the radio communication subscriber, and that the rest application software is installed and used through an automatic download whenever necessary.

As shown in FIGS. 7A and 7B, when a mobile station 720 desires to receive any service but there is no concerned application software, a cookie of the mobile station 720 selects a desired program and sends a reception requirement for the application software to the application software distribution system 700, in a step 771. Further, in case that there is no a storage space to install the application software, the cookie requires a call originating in order to store the application software used less, at a personal software storing space of the application software distribution system 700.

The mobile station 720 determines the personal identity (PID) value for receiving a transmission plan message 773 in the initialization, as a variable, and stands by to receive and process a packet transmitted from the application software distribution system 700 in a step 722.

The application software distribution system 700 having an application software reception/dispatch requirement 771 generates a thread in a step 701, and the PID and IP are initialized in a step 702. Herewith, in the initialization, the PID value for transmitting a transmission plan message is generated, and the PID value allocated for the distribution of the application software and a multicast IP address value used for the distribution of the application software are stored.

The application software distribution system 700 first searches for a subscriber database 740 to clarify in a step 703 whether it is a service subscriber, and a response message 772 to the application software reception/dispatch is transmitted to the mobile station 720.

If not the service subscriber in the result of clarifying whether or not it is the service subscriber, a service subscribing step 734 is performed and the clarification step 703 is then progressed.

Meantime, if the initialization was determined between the application software distribution system 700 as the server and the mobile station 720 as the client, a next work starts in order for the distribution and storing of the application software.

The application software distribution system 700 performs a transmission program to distribute the application software, and the transmission program constructs the transmission plan in a step 704, to send a transmission plan message 773 to the mobile station 720.

Oppositely, when the personal software is received from the mobile station 720 to the application software distribution system 700, the transmission program constructs a reception plan in a step 704 and a reception plan message 773 is transmitted to the mobile station 720.

While, when the mobile station 720 receives a response message 772 to the application software reception/dispatch from the application software distribution system 700 as the software transmission server, an application software reception program is executed according to the transmission plan and a reception plan is constructed in a step 723. In opposite, when the mobile station 720 transmits the personal software to the application software distribution system 700, the transmission program constructs the transmission plan in the step 723.

Next, a push/pull is decided in the application software distribution system 700, in a step 705.

If the pull is decided in the application software distribution system 700, the application software distribution system 700 opens and reconstructs an application software file in a software database 750 in a step 706, with the PID value of the application software to be distributed to the mobile station 720.

Then, the application software distribution system 700 sends an application software data transmission start packet 774 to the mobile station 720 and also transmits the application software file in a step 708. It is also clarified in a step 710 whether or not all the files are transmitted, and in case that there yet is the application software remained to be transmitted in the clarification result, it is progressed an application software file transmitting step 708. If all the files were transmitted, an application software transmission completion packet 776 is transmitted to the mobile station 720, a thread is finished in a step 713 and the distribution system is completed.

If the push was decided in the application software distribution system 700 in the above deciding result, the application software distribution system 700 waits for the application software transmission start packet 774 from the mobile station 720 in a step 707, when receiving the personal software. Also, an application software file packet 775 is received from the mobile station 720 under an application software file reception stand-by state 709. An error of the received application software file packet is checked in a step 711, and if there is the error, it goes to a step 709 of standing by an application software file reception. If the error does not occur, the received application software file is stored at a software database 760 in a step 712. When the application software transmission completion packet is received from the mobile station 720, the thread is completed in the step 713 and the distribution system is finished.

In opposite, an operation in the mobile station 720 is performed oppositely to that in the application software distribution system 700. That is, when the pull procedure is performed in the application software distribution system, the mobile station 720 performs the push procedure, and when the push procedure is progressed in the application software distribution system 700, the mobile station 720 operates the pull procedure. This is described more in detail, as follows.

First, the push/pull is decided in the mobile station 720 in a step 724.

If the pull is decided in such decision result, the mobile station 720 opens the application software file in a step 726, to then transmit the application software file to the application software distribution system 700 in a step 728. It is then clarified in a step 730 whether or not all the files are transmitted, and in case that there yet is the application software remained to be transmitted, it is again progressed the step 728 of transmitting the application software file. If all the files were transmitted in the decision result, the mobile station is completed.

If the push is decided in the decision result of the step 723, the mobile station 720 stands by a reception of the application software data transmission start packet 774 from the application software distribution system 700, in a step 725, and also prepares to receive the application software file in a step 727. Then, when the application software file is received from the application software distribution system 700 in a step 775, it is checked whether or not there is an error in the application software file, in a step 729. If there is the error in the checking result, it again goes to the application software file reception stand-by step 727, and if there is no the error, the received application software file is stored. When the application software transmission completion packet is received from the application software distribution system 700 in a step 776, the received application software file is checked in a step 732. If there is an abnormality in the checked file, it again goes to the application software reception requiring step 771, and if there is no the abnormality, the application software file is stored automatically in a step 733.

Meantime, when the user of the mobile station uses the application software down-loaded by using the distribution service, it is sensed whether the user is the subscriber of its own company or is non-subscriber of other company. Further, when the radio communication subscriber uses the application software, it can be provided a method of using by free of charge or by charge, and a method that the radio communication subscriber watches advertisement information in the midst of using the application software or of non-using time, or after ceasing its use for a moment, or through the advertisement information represented on a lower part of the mobile station screen, and also a method that the non-subscriber may watch the advertisement information by free of charge since the charging method is impossible. Even though the user is the non-subscriber, it can be provided equally to the method for the radio communication subscriber through a specific subscribing procedure for a multimedia service.

The above-mentioned inventive method can be embodied as a program and can be also stored at a record medium as a type capable of being read by a computer, the record medium being as CDROM, RAM, ROM, a floppy disk, a hard disk, an optic-magnetic disk, etc.

As afore-mentioned, in accordance with the present invention, a limitation in a hardware of a mobile station can be overcome to provide various application services and a convenience for the mobile station can be increased largely.

In addition, an efficiency of the mobile station can be widened, and according to that, a radio portal service based on a radio internet can be activated, to thereby extend a market of an application service concerning of a general radio internet through the mobile station.

It will be apparent to those skilled in the art that various modifications and variations can be made in the present invention without deviating from the spirit or scope of the invention. Thus, it is intended that the present invention cover the modifications and variations of this invention provided they come within the scope of the appended claims and their equivalents.

What is claimed is:

1. A method for distributing application software applied to an application software distribution system, comprising the steps of:
a) initializing to distribute application software files to a mobile station;
b) receiving an application software transmission/reception requiring message from the mobile station;
c) if the application software transmission requiring message is received, transmitting the application software file to the mobile station; and
d) if the application software reception requiring message is received, receiving the application software file from the mobile station.

2. The method as recited in claim 1, before the step a), further comprising the step of:
e) generating a thread in the application software distribution system.

3. The method as recited in claim 2, wherein the step c) includes the steps of:
c1) constructing a transmission plan in the application software distribution system and transferring a transmission plan message to the mobile station;
C2) opening an application software file to be transmitted; and
C3) transmitting the application software file to the mobile station.

4. The method as recited in claim 3, before the step c1) further including the step of:
c4) transmitting a response message to the application software transmission requiring message.

5. The method as recited in claim 2, wherein the step d) includes the steps of:
d1) constructing a reception plan in response to an application software reception requiring message;
d2) receiving application software file packets;
d3) determining whether there is an error in the application software file packets; and
d4) if there is no error in the application software file packet, storing the application software file packets.

6. The method as recited in claim 3 or 5, before the step b), further including the step of:
f) confirming that the mobile station is a service subscriber.

7. The method as recited in claim 4, further including the steps of:
c5) if all of the application software files are transmitted, transmitting an application software transmission completion packet to the mobile station;
c6) receiving an application software transmission requirement releasing message from the mobile station; and
c7) terminating the thread.

8. The method as recited in claim 7, wherein the application software distribution system stores charging information to make a user of the mobile station chargeable for an execution of said application software program.

9. The method as recited in claim 10, wherein the step a) includes the steps of:
a1) generating a program identity (PID) allocated to transmit the application software transmission plan message; and
a2) storing the PID and an internet protocol (IP) address allocated to transmit the application software are stored.

10. The method as recited in claim 9, further including the step of performing a data backup for information concerned with the user of the mobile station through a data backup equipment, when the mobile station is not used for a constant period by automatically checking a using period of the user of the mobile station.

11. The method as recited in claim 10, wherein the application software distribution system differentially provides a storing space in accordance with an age or an occupation of the user of the mobile station.

12. A method for distributing application software file applied to a mobile station, comprising the steps of:
a) performing an initialization in the mobile station;
b) transmitting an application software transmission/reception requiring message to an application software distribution system;
c) if the application software transmission requiring message is transmitted, receiving an application software file from the application software distribution system; and
d) if the application software reception requiring message is transmitted, transmitting the application software file.

13. The method as recited in claim 12, after the step c), further comprising the steps of:
e) installing the application software file.

14. The method as recited in claim 13, before the step a), further comprising the steps of:
f) selecting an application software program necessary for the mobile station, if there is no necessary application software file.

15. The method as recited in claim 15, after the step b), further including the step of:
g) receiving a response to the application software reception requirement message.

16. The method as recited in claim 15, wherein the step c) includes the steps of:
c1) receiving a transmission plan message from an application software distribution system;
c2) constructing a reception plan;
c3) receiving an application software transmission start packet from the application software distribution system;
c4) standing by to receive an application software file;
c5) receiving the application software file from the application software distribution system; and
b6) storing the application software file.

17. The method as recited in claim 16, after the step c5), further including the step of:
c6) performing an error checking of the application software file.

18. The method as recited in claim 15, wherein the step e) includes the steps of:
e1) receiving an application software transmission completion packet from the application software distribution system;
e2) determining whether there is an error in the application software file; and
e3) if there is no error in the application software file, installing the application software file.

19. The method as recited in claim 18, further including the step of performing a data backup for information concerned with the user of the mobile station through a data backup equipment, when the mobile station is not used for a constant period by automatically checking a using period of the user of the mobile station.

20. The method as recited in claim 10, wherein the step a) includes the steps of:
a1) generating a program identity (PID) allocated to transmit the application software transmission plan message; and
a2) storing the PID and an internet protocol (IP) address allocated to transmit the application software are stored.

21. The method as recited in claim 20, wherein the application software distribution system differentially provides a storing space in accordance with an age or an occupation of the user of the mobile station.

22. The method as recited in claim 23, wherein the mobile station deletes the application software or transmits the application software to the storing space of the application software distribution system, if the storing space of the mobile station is shortage.

23. The method as recited in claim 22, further including the step of automatically connecting to a server designated by a uniform resource locator (URL) of a specified site, when the application software file distributed from the application software distribution system is executed, the URL being set inside the application software.

24. A computer readable record medium storing instructions for executing a method for distributing application software applied to an application software distribution system, the method comprising the steps of:
a) initializing to distribute application software files to a mobile station;
b) receiving an application software transmission/reception requiring message from the mobile station;
c) if the application software transmission requiring message is received, transmitting the application software file to the mobile station; and
d) if the application software reception requiring message is received, receiving the application software file from the mobile station.

25. A computer readable record medium storing instructions for executing a method for distributing application software applied to an mobile station, the method comprising the steps of:
a) performing an initialization in the mobile station;
b) transmitting an application software transmission/reception requiring message to an application software distribution system;
c) if the application software transmission requiring message is transmitted, receiving an application software file from the application software distribution system; and
d) if the application software reception requiring message is transmitted, transmitting the application software file.
